(19) United States
(12) Patent Application Publication
(10) Pub. No.: US 2006/0168737 A1
(43) Pub. Date: Aug. 3, 2006

(54) Method for synthetic fiber reduction treatment

(75) Inventors: Huan-Sheng Chien, Taoyuan Hsien (TW); Yu-Chi Tseng, Chungli City (TW)

Correspondence Address: SUGHRUE MION, PLLC, 2100 PENNSYLVANIA AVENUE, N.W., SUITE 800, WASHINGTON, DC, 20037, US

(73) Assignee: TAIWAN TEXTILE RESEARCH INSTITUTE

(21) Appl. No.: 11/249,491

(22) Filed: Oct. 14, 2005

(30) Foreign Application Priority Data
Jan. 28, 2005 (TW) 94102790

(51) Int. Cl. C11D 3/00

(52) U.S. Cl. 8/115.51

(57) ABSTRACT

An improved method for a synthetic fiber reduction treatment comprises a reagent-immersing treatment and a supersonic impact treatment. A synthetic fiber is immersed in a reagent and a supersonic impact treatment is used to impact the reagent simultaneously.

### RELATED APPLICATIONS

The present application is based on, and claims priority from, Taiwan Application Serial Number 94102790, filed Jan. 28, 2005, the disclosure of which is hereby incorporated by reference herein in its entirety.

### FIELD OF THE INVENTION

The present invention relates to a technology for producing synthetic fiber, and particularly relates to a method for synthetic fiber reduction treatment.

### BACKGROUND OF THE INVENTION

Natural textile materials, such as cotton, wool and linen, have not satisfied the demands of various applications, such as environmental, healthcare and scientific applications. Thus, the textile industries have been ceaselessly searching for new textile materials. Synthetic fiber materials having smooth, sleek fibers, good drapability, and flexibility can satisfy the various requirements of such applications.

However, synthetic fiber materials do not provide comfort of touch as well as natural textile materials. Synthetic fiber materials having uniform shape are different from natural textile materials that have various shapes and sizes obtained from various plants and animals. The uniform fiber shape of synthetic fiber results in hydrophobia, but does not provide as much fluffiness and comfort as natural textile materials.

To resolve this problem, several improved technologies, such as the suede-process and porous-structure forming process, have been provided for synthetic fiber materials to obtain various physical properties and make them more comfortable to touch.

In general, the improved technologies aforementioned comprise an alkaline reduction treatment to dissolve a portion of a processing synthetic fiber. For example, an alkaline reagent of 2% to 5% by weight is used to dissolve a portion of the processing synthetic fiber for forming porosity therein, or for forming a suede structure to obtain desired drapability and tactility. The alkaline can also be used for removing treatment reagents during the synthesizing of synthetic fiber materials.

However, the alkaline reduction treatment may damage the desired structure and the physical properties of synthetic fiber materials. In addition, the alkaline reagent may increase the cost of wastewater treatment.

To resolve these problems, water-soluble polyesters are used as modifying monomers for synthesizing the synthetic fiber materials. Porous and/or suede structures may be obtained after dissolving the water-soluble polyester of the synthetic fiber materials. Thus, the use of alkaline reagent can be reduced. However, suitable synthetic fiber materials for this process may be rather restricted. Another solution involves using water-soluble and organic-reagent-soluble modifying particles for synthesizing the synthetic fiber materials. Porous structures can also be obtained by dissolving the water-soluble and organic-reagent-soluble particles by organic reagent. Although the use of alkaline reagent can be reduced, however, there are still additional costs for treating the organic reagent.

Accordingly, it is desired to provide an improved reduction treatment method with high reduction efficiency and less wastewater pollution.

### SUMMARY OF THE INVENTION

Therefore, the objective of the present invention is to provide an improved method for reduction treatment. The improved method of reduction treatment characterizes using supersonic impact to assist the performance of the reduction treatment. The supersonic impact provided by a supersonic generator can increase the performance and reduce the concentration of the treating reagent, thus reducing the load on waste treatment.

The improved method of reduction treatment of the present invention comprises a reagent-immersing treatment and a supersonic impact treatment. In some preferred embodiments, the reagents used in the reagent-immersed reduction process comprise water, organic solvent, or alkaline solution. The amplitude of vibration generated by the supersonic impact treatment ranges from about 120 μm to 160 μm.

In a preferred embodiment of the present invention, an experiment is conducted to compare the performance of the present invention with that of the prior art. The results of the experiment show that the efficiency of the present method is at least two times greater than that of the traditional method.

Accordingly, the present method that uses supersonic impact to assist the performance of the reduction treatment can improve the fiber reduction efficiency and simultaneously reduce the cost of wastewater treatment.

### DETAILED DESCRIPTION OF THE PREFERRED EMBODIMENT

The objective of the present invention is to provide an improved method for reduction treatment. The present method uses supersonic impact in association with the reagent-immersing treatment to increase the efficiency of the traditional reduction treatment and simultaneously reduce the cost of subsequent wastewater treatment.

The improved method of the present invention is used for treating synthetic fiber materials, such as those made from polyester synthetic fibers, polyamid synthetic fibers, and polyolefin synthetic fibers, wherein the fineness of the synthetic fiber materials range from about 0.5 d (denier) to 20 d. The cross-sectional shape of the synthetic fiber materials is selected from a group consisting of full circular, hollow circular, cross, triangular, polygon, Sea & Island, Split, Sheath & Core, Side by Side, and any arbitrary combination thereof.

The improved method can be used in the suede-process for forming a suede structure. In some embodiments of the present invention, the improved method is used for removing the sea portion of a Sea & Island type synthetic fiber during a suede-process. In other embodiments of the present invention, the improved method of the present invention can also be used in the porous-structure forming process for removing portions of the processing synthetic fibers to form porous structures.

The foregoing aspects and many of the attendant advantages of this invention will become more readily appreciated as the same becomes better understood by reference to the following detailed description of four preferred embodiments.

### The First Embodiment

In the first embodiment, a porous-structure forming process is conducted on a modified synthetic fiber that has alkaline-soluble polyester. The present method is used for removing the alkaline-soluble polyester from the modified synthetic fiber to form a porous structure thereof.

The modified synthetic fiber is made of organic sulphonate monomer, polyester monomer and polyethylene tetrephthalate, wherein the organic sulphonate salts are polymerized with polyester monomer to form a modifying monomer. Then, a spinning process is conducted with the modified monomer and polyethylene tetrephthalate to form the modified synthetic fiber. Alternatively, metallic sulphonate salts can be used as modifying monomers, wherein the metallic sulphonate salts may be added to the polyethylene tetrephthalate during any step of the spinning process.

According to the first embodiment, the modified synthetic fiber is immersed in an alkaline solution, such as sodium hydroxide solution or potassium hydroxide solution. In the preferred embodiment, the concentration of the sodium hydroxide solution ranges from about 2% to 10%. The temperature of the sodium hydroxide solution may be maintained from about 70° C. to 90° C. Simultaneously, a supersonic impact treatment is conducted. A supersonic generator is used for generating supersonic waves to impact on the sodium hydroxide solution, creating cavitation, wherein numerous vacuum bubbles generated by the supersonic waves break with great impact upon the synthetic fiber. The amplitude of vibration generated by the supersonic impact treatment ranges from about 120 μm to 160 μm. After about 10 minutes of treatment, the sodium hydroxide solution can be removed to complement the reduction treatment.

### The Second Embodiment

In the second embodiment, a porous-structure forming process is conducted on a synthetic fiber that has alkaline-soluble polyester. The present method is used for removing the alkaline-soluble polyester from the synthetic fiber to form a porous structure thereof.

The modified synthetic fiber is made of polyethylene tetrephthalate and poly(ethylene glycol) or poly(ethylene glycol) ester. A spinning process is conducted with polyethylene tetrephthalate to form the synthetic fiber having polyester, wherein the poly(ethylene glycol) or poly(ethylene glycol) ester may be added to the polyethylene tetrephthalate during any step of the spinning process.

According to the second embodiment, the synthetic fiber having polyester is immersed in an alkaline solution, such as sodium hydroxide solution or potassium hydroxide solution. In the preferred embodiment, the concentration of the sodium hydroxide solution ranges from about 2% to 10%. The temperature of the sodium hydroxide solution may be maintained from about 70° C. to 90° C. Simultaneously, a supersonic impact treatment is conducted. A supersonic generator is used for generating supersonic waves to impact the sodium hydroxide solution, creating cavitation, wherein numerous vacuum bubbles generated by the supersonic waves break with great impact upon the synthetic fiber. The amplitude of vibration generated by the supersonic impact treatment ranges from about 120 μm to 160 μm. After about 10 minutes of treatment, the sodium hydroxide solution can be removed to complement the reduction treatment.

### The Third Embodiment

In the third embodiment, a porous-structure forming process is conducted on a modified synthetic fiber that has water-soluble polyester. The present method is used for removing the water-soluble polyester from the modified synthetic fiber to form a porous structure thereof.

The modified synthetic fiber is made of polyethylene tetrephthalate and water-soluble polyester or water-soluble polyamide. A spinning process is conducted with polyethylene tetrephthalate to form the modified synthetic fiber, wherein the water-soluble polyester or water-soluble polyamide may be added to the polyethylene tetrephthalate during any step of the spinning process.

According to the third embodiment, the modified synthetic fiber is immersed in water. In the preferred embodiment, the temperature of water may be maintained from about 70° C. to 90° C. Simultaneously, a supersonic impact treatment is conducted. A supersonic generator is used for generating supersonic waves to impact the water, creating cavitation, wherein numerous vacuum bubbles generated by the supersonic waves break with great impact on the modified synthetic fiber. The amplitude of vibration generated by the supersonic impact treatment ranges from about 120 μm to 160 μm. After about 10 minutes of treatment, the water solution can be removed to complement the reduction treatment.

### The Fourth Embodiment

In the fourth embodiment, a porous-structure forming process is conducted on a modified synthetic fiber that has organic solvent-soluble polyester. The present method is used for removing the organic solvent-soluble polyester from the modified synthetic fiber to form a porous structure thereof.

The modified synthetic fiber is made of polyethylene tetrephthalate and organic solvent-soluble modifying particles or organic solvent-soluble polyamide. A spinning process is conducted with polyethylene tetrephthalate to form the modified synthetic fiber, wherein the organic solvent-soluble modifying particles may be added to the polyethylene tetrephthalate during any step of the spinning process.

According to the fourth embodiment, the modified synthetic fiber is immersed in an organic solution, such as benzene, alcohol, aldehyde, phenol, or any arbitrary combination thereof. In the preferred embodiment, the organic solution is benzene and the temperature is maintained from about 70° C. to 90° C. Simultaneously, a supersonic impact treatment is conducted. A supersonic generator is used for generating supersonic waves to impact the organic solution, creating cavitation, wherein numerous vacuum bubbles generated by the supersonic waves break with great impact on the modified synthetic fiber. The amplitude of vibration generated by the supersonic impact treatment ranges from about 120 μm to 160 μm. After about 10 minutes of treatment, the organic solution can be removed to complement the reduction treatment.

According to the objectives of the present invention, an experiment is conducted to compare the performance of the present method with that of the prior art to show that the reduction efficiency of the present method is greater than that of the traditional method. The modified synthetic fiber aforementioned in the first embodiment and a commercial synthetic fiber having polyester are used for the experiment. And the experiment is repeated 10 times to obtain the results.

With regard to the method of the prior art, the commercial synthetic fiber is divided into two bundles respectively. The two bundles are immersed in two sodium hydroxide solution having different concentrations, respectively, wherein one of the solutions has a concentration of 2% by weight and the other of 10% by weight. The immersing temperatures of these sodium hydroxide solutions are both 80° C. The result is determined after a treatment duration of 10 minutes. Similarly, the modified synthetic fiber is divided into two bundles, respectively. The two bundles are immersed in two sodium hydroxide solutions having different concentrations, respectively, wherein one of the solutions has a concentration of 2% by weight and the other of 10% by weight. The immersing temperatures of the sodium hydroxide solutions are both maintained at 80° C. The result is determined after a treatment duration of 10 minutes.

With regard to the present method of reduction treatment, the commercial synthetic fiber is divided into two bundles, respectively. The two bundles are immersed in two sodium hydroxide solutions having different concentrations, respectively, wherein one of the solutions has a concentration of 2% by weight and the other of 10% by weight. The immersing temperatures of the sodium hydroxide solutions are both maintained at 80° C. Simultaneously, a supersonic impact treatment is conducted. A supersonic generator is used for generating supersonic waves to impact the sodium hydroxide solution for 10 minutes. The result is determined after the process aforementioned. Similarly, the modified synthetic fiber is divided into two bundles respectively. The two bundles are immersed in two sodium hydroxide solutions with different concentrations, respectively, wherein one of the solutions has a concentration of 2% by weight and the other of 10% by weight. The immersing temperatures of the sodium hydroxide solutions are both maintained at 80° C. Simultaneously, the supersonic impact treatment aforementioned is conducted. A supersonic generator is used for generating supersonic waves to impact the sodium hydroxide solution for 10 minutes. The result is determined after the process aforementioned.

The results of the experiment are shown in the following table:

| | Reduction Treatment | | | |
|---|---|---|---|---|
| | Reduction Ratio (%) | | | |
| | Prior art | | Present invention | |
| | Commercial | Modified | Commercial | Modified |
| | Synthetic | Synthetic | Synthetic | Synthetic |
| Concentrations | fibers | fibers | fibers | fibers |
| 2 Wt % NaOH | 0.5-1 (%) | 25-30 (%) | 3-4 (%) | 60-70 (%) |
| 10 Wt % NaOH | 2-3 (%) | 45-50 (%) | 8-10 (%) | 90-100 (%) |

According to the results of the experiment, the reduction ratios of the present method are at least 3 times greater than that of the prior art when the commercial synthetic fiber is used. The reduction ratios of the present method are at least 2 times greater than that of the prior art when the modified synthetic fiber is used. Therefore, the present method can improve the fiber reduction efficiency without increasing the concentration of the treating reagent and can thus simultaneously decrease the cost of wastewater treatment.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An improved method for synthetic fiber reduction treatment, comprising:
immersing a synthetic fiber in a reagent; and
conducting a supersonic impact treatment simultaneously, wherein a supersonic impact generator is used to impact the reagent.

2. The improved method according to claim 1, wherein the synthetic fiber reduction treatment is used for a porous-structure forming process or a suede-process.

3. The improved method according to claim 1, wherein the synthetic fiber is selected form a group consisting of polyester synthetic fibers, polyamide synthetic fibers, polyolefin synthetic fibers, and any arbitrary combination thereof.

4. The improved method according to claim 3, wherein the synthetic fiber has a fineness ranging from about 0.5 d (denier) to 20 d.

5. The improved method according to claim 3, wherein the synthetic fiber has a cross-sectional shape selected from a group consisting of a full circular type, hollow circular type, cross type, triangular type, polygonal type, Sea & Island type, Split type, Sheath & Core type, Side by Side type, and any arbitrary combination thereof.

6. The improved method according to claim 1, wherein the reagent is selected from a group consisting of alkaline solution, water, organic reagent, and any arbitrary combination thereof.

7. The improved method according to claim 6, wherein the alkaline solution is selected from a group consisting of sodium hydroxide, potassium hydroxide, and any arbitrary combination thereof.

8. The improved method according to claim 6, wherein the organic reagent is selected from a group consisting of benzene, alcohol, aldehyde, phenol, and any arbitrary combination thereof.

9. The improved method according to claim 1, wherein the supersonic impact treatment has an amplitude of vibration ranging from about 120 μm to 160 μm.
